(19) United States
(12) Patent Application Publication
(10) Pub. No.: US 2022/0119014 A1
(43) Pub. Date: Apr. 21, 2022

(54) Apparatus for Controlling Behavior of Autonomous Vehicle and Method for the Same

(71) Applicants: Hyundai Motor Company, Seoul (KR); Kia Corporation, Seoul (KR)

(72) Inventor: Chan Hee Jung, Seoul (KR)

(21) Appl. No.: 17/325,315

(22) Filed: May 20, 2021

(30) Foreign Application Priority Data
Oct. 20, 2020 (KR) 10-2020-0136228

(51) Int. Cl. B60W 60/00; B60W 50/08; B60W 40/08

(52) U.S. Cl. CPC B60W 60/0051; B60W 60/0053; B60W 50/087; B60W 2540/10; B60W 40/08; B60W 2540/18; B60W 2540/12; B60W 60/0015

(57) ABSTRACT

An embodiment apparatus is configured to control a behavior of an autonomous vehicle. An input device is configured to receive an operation amount of a driver for the behavior of the autonomous vehicle, and a controller is configured to, while the autonomous vehicle is driving in an autonomous vehicle mode, receive the operation amount of the driver through the input device, predict a collision with a surrounding vehicle based on the operation amount of the driver, and adjust the operation amount of the driver to prevent the collision with the surrounding vehicle.

### CROSS-REFERENCE TO RELATED APPLICATIONS

This application claims the benefit of Korean Application No. 10-2020-0136228, filed on Oct. 20, 2020, which application is hereby incorporated herein by reference.

### TECHNICAL FIELD

The present disclosure relates to an apparatus for controlling behavior of an autonomous vehicle and a method for the same.

### BACKGROUND

In general, an autonomous vehicle may control various devices including a steering device to recognize a road environment for itself, to determine a driving situation, and to move a scheduled driving path to a target position from a current position.

Such an autonomous vehicle may be equipped with Autonomous Emergency Braking (AEB), Forward Collision Warning System (FCW), Adaptive Cruise Control (ACC), Lane Departure Warning System (LDWS), Lane Keeping Assist System (LKAS), Blind Spot Detection (BSD), Rear-end Collision Warning System (RCW), and Smart Parking Assist System (SPAS).

Accordingly, the autonomous vehicle may recognize a surrounding vehicle and a driving lane, may maintain a certain distance from a preceding vehicle during driving, may maintain a current driving lane, or may change the driving lane depending on a situation.

Meanwhile, the autonomous vehicle may directly transfer a control right over the autonomous vehicle to a driver, when the driver is involved (for example, when the driver operates a brake pedal, an accelerator pedal, or a steering wheel).

When the autonomous vehicle is driving in the autonomous driving mode, the driver may not fully determine a surrounding driving situation, since the driver does not take care of driving. When the driver is involved in such a situation, an accident (the collision with a surrounding vehicle) may be caused.

Therefore, according to the conventional technology of controlling the behavior of the autonomous vehicle, when the driver is involved in the driving in the autonomous driving mode, the operation amount (for example, a braking amount, an accelerating amount, or a steering amount) of a driver may be reflected in the behavior of the autonomous vehicle.

The matter described in the “Background” section is made for the convenience of explanation, and may include matters other than a related art well known to those skilled in the art.

### SUMMARY

The present disclosure relates to an apparatus for controlling behavior of an autonomous vehicle and a method for the same. Particular embodiments relate to a technology of preventing the collision with a surrounding obstacle (e.g., a vehicle, a motorcycle, a pedestrian, a bicycle, or road facilities) when a driver is involved in driving while an autonomous vehicle is driving in an autonomous driving mode. Embodiments of the present disclosure can solve problems occurring in the prior art while advantages achieved by the prior art are maintained intact.

An embodiment of the present disclosure provides an apparatus for controlling a behavior of an autonomous vehicle and a method for the same, capable of predicting a collision with a surrounding vehicle, which is caused by an operation amount (e.g., a braking amount, an accelerating amount, or a steering amount) of a driver, when the driver is involved in driving while an autonomous vehicle is driving in an autonomous mode, and adjusting (changing) the operation amount of the driver to prevent the collision with the surrounding vehicle, thereby preventing a traffic accident from being caused as the driver is involved in the driving.

The technical problems that may be solved by embodiments of the present disclosure are not limited to the aforementioned problems, and any other technical problems not mentioned herein will be clearly understood from the following description by those skilled in the art to which the present disclosure pertains. In addition, it can be easily understood that the objects and the features of embodiments of the present disclosure are realized by means and the combination of the means claimed in appended claims.

According to an embodiment of the present disclosure, an apparatus for controlling a behavior of an autonomous vehicle may include an input device to receive an operation amount of a driver for the behavior of the autonomous vehicle, and a controller to predict a collision with a surrounding vehicle, based on the operation amount of the driver, and to adjust the operation amount of the driver to prevent the collision with the surrounding vehicle, when receiving the operation amount of the driver through the input device while the autonomous vehicle is driving in an autonomous vehicle mode.

According to an embodiment of the present disclosure, the controller may set a safety zone based on the autonomous vehicle, which is driving, to prevent the collision with the surrounding vehicle.

According to an embodiment of the present disclosure, the input device may receive a steering amount of the driver from a steering angle sensor.

According to an embodiment of the present disclosure, the controller may predict a driving path of the autonomous vehicle based on the steering amount of the driver, determine whether the autonomous vehicle deviates from the safety zone when following the predicted driving path, and adjust the steering amount of the driver to prevent the autonomous vehicle from deviating from the safety zone.

According to an embodiment of the present disclosure, the input device may receive a braking amount of the driver from a Brake-pedal Position Sensor (BPS).

According to an embodiment of the present disclosure, the controller may predict a position of the autonomous vehicle based on the braking amount of the driver, determine whether the predicted position of the autonomous vehicle is out of the safety zone, and adjust the braking amount of the driver to prevent the position of the autonomous vehicle from being out of the safety zone.

According to an embodiment of the present disclosure, the input device may receive an accelerating amount of the driver from an Accel-pedal Position Sensor (APS).

According to an embodiment of the present disclosure, the controller may predict a position of the autonomous vehicle based on the accelerating amount of the driver, determine whether the predicted position of the autonomous vehicle is out of the safety zone, and adjust the accelerating amount of the driver to prevent the position of the autonomous vehicle from being out of the safety zone.

According to an embodiment of the present disclosure, the controller may transfer a control right over the autonomous vehicle to the driver, when the autonomous vehicle is positioned in the safety zone by adjusting the operation amount of the driver.

According to an embodiment of the present disclosure, the controller may transfer a control right over the autonomous vehicle to the driver, when a total time, for which the operation amount of the driver is adjusted, exceeds a reference time.

According to another embodiment of the present disclosure, a method for controlling a behavior of an autonomous vehicle may include receiving, via an input device, an operation amount of a driver for the behavior of the autonomous vehicle while the autonomous vehicle is driving in an autonomous driving mode, and predicting, by a controller, a collision with a surrounding vehicle, based on an operation amount of the driver to adjust the operation amount of the driver to prevent the collision with the surrounding vehicle.

According to an embodiment of the present disclosure, a safety zone may be set, based on the autonomous vehicle which is driving, to prevent the collision with the surrounding vehicle.

According to an embodiment of the present disclosure, the method may include receiving a steering amount of the driver from a steering angle sensor.

According to an embodiment of the present disclosure, the method may include predicting a driving path of the autonomous vehicle based on the steering amount of the driver, determining whether the autonomous vehicle deviates from the safety zone when following the predicted driving path, and adjusting the steering amount of the driver to prevent the autonomous vehicle from deviating from the safety zone.

According to an embodiment of the present disclosure, the method may include receiving a braking amount of the driver from a BPS.

According to an embodiment of the present disclosure, the method may include predicting a position of the autonomous vehicle based on the braking amount of the driver, determining whether the predicted position of the autonomous vehicle is out of the safety zone, and adjusting the braking amount of the driver to prevent the position of the autonomous vehicle from being out of the safety zone.

According to an embodiment of the present disclosure, the method may include receiving an accelerating amount of the driver from an APS.

According to an embodiment of the present disclosure, the method may include predicting a position of the autonomous vehicle based on the accelerating amount of the driver, determining whether the predicted position of the autonomous vehicle is out of the safety zone, and adjusting the accelerating amount of the driver to prevent the position of the autonomous vehicle from being out of the safety zone.

According to an embodiment of the present disclosure, the method may include transferring, by the controller, a control right over the autonomous vehicle to the driver, when the autonomous vehicle is positioned in the safety zone by adjusting the operation amount of the driver.

According to an embodiment of the present disclosure, the method may further include transferring, by the controller, a control right over the autonomous vehicle to the driver, when a total time, for which the operation amount of the driver is adjusted, exceeds a reference time.

### BRIEF DESCRIPTION OF THE DRAWINGS

The above and other objects, features and advantages of embodiments of the present disclosure will be more apparent from the following detailed description taken in conjunction with the accompanying drawings, in which:

FIG. 1 is a view illustrating the configuration of an autonomous vehicle, according to an embodiment of the present disclosure;

FIG. 2A is a block diagram illustrating a behavior controlling apparatus of an autonomous vehicle, according to an embodiment of the present disclosure;

FIG. 2B is a detailed block diagram illustrating a controller provided in a behavior controlling apparatus of an autonomous vehicle, according to an embodiment of the present disclosure;

FIG. 3 illustrates a safety zone set by a controller provided in a behavior controlling apparatus of an autonomous vehicle, according to an embodiment of the present disclosure;

FIG. 4 is a view illustrating a process that a controller provided in a behavior controlling apparatus of an autonomous vehicle adjusts a steering amount of a driver, according to an embodiment of the present disclosure;

FIG. 5 is a view illustrating a process that a controller provided in a behavior controlling apparatus of an autonomous vehicle adjusts a braking amount of a driver, according to an embodiment of the present disclosure;

FIG. 6 is a view illustrating a process that a controller provided in a behavior controlling apparatus of an autonomous vehicle adjusts an accelerating amount of a driver, according to an embodiment of the present disclosure;

FIG. 7 is a flowchart illustrating a method for controlling a behavior of an autonomous vehicle, according to an embodiment of the present disclosure; and

FIG. 8 is a block diagram illustrating a computing system to execute a method for controlling a behavior of an autonomous vehicle, according to an embodiment of the present disclosure.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiments of the present disclosure, a detailed description of well-known features or functions will be omitted in order not to unnecessarily obscure the gist of the present disclosure.

In addition, in the following description of components according to an embodiment of the present disclosure, the terms ‘first’, ‘second’, ‘A’, ‘B’, ‘(a)’, and ‘(b)’ may be used. These terms are merely intended to distinguish one component from another component, and the terms do not limit the nature, sequence or order of the constituent components. In addition, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

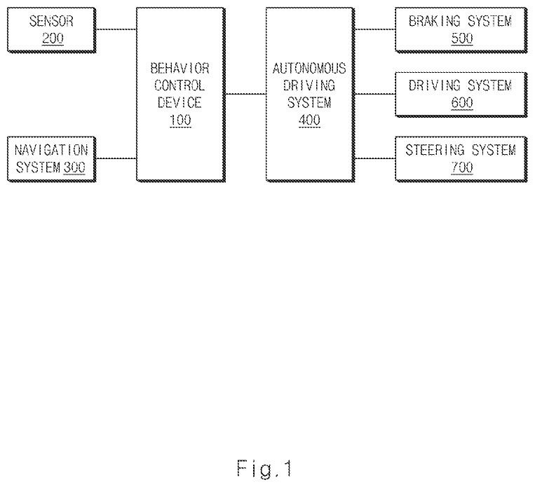

FIG. 1 is a view illustrating the configuration of an autonomous vehicle, according to an embodiment of the present disclosure.

As illustrated in FIG. 1, the autonomous vehicle according to an embodiment of the present disclosure may include an apparatus (behavior controlling apparatus or behavior control device) 100 for controlling a behavior of the autonomous vehicle, a sensor 200, a navigation system 300, an autonomous driving system 400, a braking system 500, a driving system 600, and a steering system 700.

The behavior controlling apparatus 100 may predict a collision with a surrounding vehicle, which is caused by an operation amount (e.g., a braking amount, an accelerating amount, or a steering amount) of a driver, when the driver is involved in driving while the autonomous vehicle is driving in an autonomous mode, and may adjust (change) the operation amount of the driver to prevent the collision with the surrounding vehicle, through the configuration of embodiments of the present disclosure.

The sensor 200 may include a light detection and ranging (LiDAR) sensor, a camera, and/or a radio detecting and ranging (RaDar) sensor. In this case, the LiDar sensor, which is a kind of environment sensor, is installed in the autonomous vehicle to apply a laser beam in all directions while rotating, and to measure position coordinates of a reflector based on a returning time of a reflected laser beam. The camera may capture an image including an obstacle (a vehicle, a motorcycle, a pedestrian, a bicycle, and road facilities) positioned around the autonomous vehicle. The radar sensor is to measure the distance to an object and the direction of the object by receiving an electromagnetic wave reflected from the object after applying an electromagnetic wave. The radar sensor may be mounted on a front bumper and a rear portion of the autonomous vehicle to recognize a long-distance object and may be hardly affected by the weather.

The navigation system 300 includes a GPS receiver, which receives a Global Positioning System (GPS) signal from a satellite and generates first position data based on the received GPS signal, a DeadReckoning (DRA) sensor, which generates second position data, based on a driving direction of the autonomous vehicle and the speed of the autonomous vehicle, a memory to store map data and various information, and a map matching device which estimates the position of the autonomous vehicle, based on the first position data and the second position data, matches the estimated autonomous vehicle to a link (a map matching size or a map matching road) on map data, and outputs map information (map matching result).

In this case, the signal received through the GPS device may provide position information of the autonomous vehicle to the navigation system 300 through a wireless communication scheme such as IEEE 802.11, which is a standard of a wireless network for a wireless LAN recommended in Institute of Electrical and Electronics Engineers (IEEE) and a wireless LAN partially including infrared communication, IEEE 802.15, which is a standard for wireless Personal Area Network (PAN) including Bluetooth, Ultra Wide Band (UWB), or Zigbee, IEEE 802.16, which is a standard for wireless Metropolitan Area Network (MAN) including Fixed Wireless Access (FWA), and IEEE 802.20 which is a standard for Mobile Broadband Wireless Access (MBWA) including Wibro or WiMAX.

The autonomous driving system 400 is a system which is able to perform Partial Automation in level 3 or High Automation in level 4. For example, the autonomous driving system 400 may be a front information detector to obtain line data from image data for a front portion of the autonomous vehicle and/or to obtain distance information for a front object through the radar data, a vehicle speed detector to measure a driving vehicle speed based on revolutions per minutes (RPM) of an output shaft of a transmission, a steering angle detector to detect the change of a steering angle as the steering wheel operates, and a controller to detect direction angles of opposite lanes of the driving road as being in a non-parallel state in which the difference between the direction angles is equal to or greater than a specific value and to correct lane information based on curve information obtained from a stationary object positioned in front.

The braking system 500 may include an actuator which controls deceleration of the autonomous vehicle. In this case, the actuator may be implemented with an electronic stability control (ESC) system. The braking system 500 may adjust braking pressure to follow a target speed during autonomous driving.

The driving system 600 may include an actuator which controls acceleration of the autonomous vehicle. In this case, the actuator may be implemented with an Engine Management System (EMS). The driving system 600 may control the driving torque of an engine, based on a position value of an accelerator pedal (depressed amount of the accelerator pedal) output from an Accel-pedal Position Sensor (APS). In addition, the driving system 600 may control the output of the engine to follow the target speed in the autonomous driving mode.

The steering system 700 may include an actuator which controls the steering of the autonomous vehicle. In this case, the actuator may be implemented with Motor Drive Power Steering (MDPS).

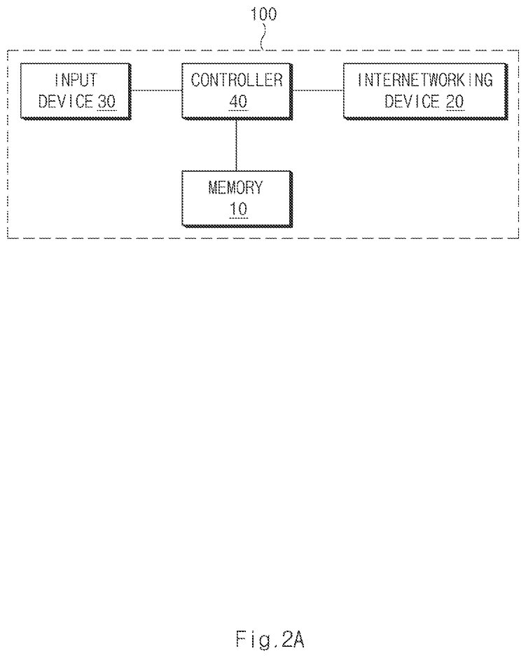

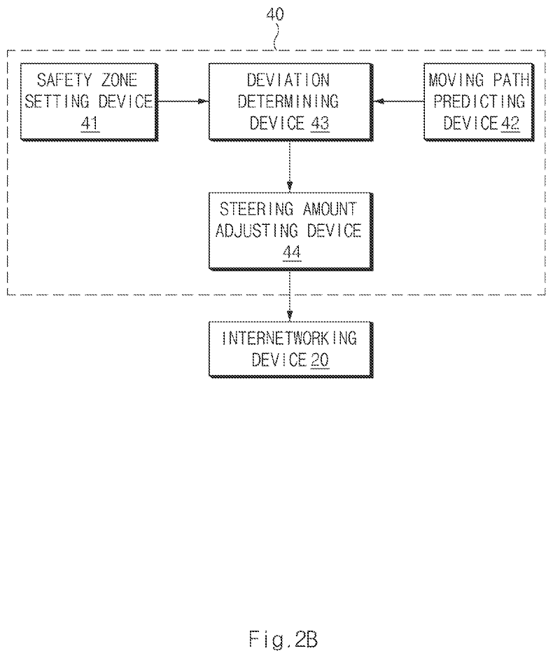

FIG. 2A is a block diagram illustrating a behavior controlling apparatus of an autonomous vehicle, according to an embodiment of the present disclosure.

As illustrated in FIG. 2A, according to an embodiment of the present disclosure, the behavior controlling apparatus 100 may include a memory (i.e., storage) 10, an internetworking device 20, an input device 30, and a controller 40. In this case, according to an embodiment of the present disclosure, the components may be combined into each other to be implemented in one form, or some components may be omitted, depending on the manners of reproducing the behavior controlling apparatus 100.

Regarding the components, the memory 10 may store various logics, various algorithms, and various programs required in the process of predicting the collision with a surrounding vehicle, which is caused by an operation amount (e.g., a braking amount, an accelerating amount, or a steering amount) of a driver, when the driver is involved in driving while the autonomous vehicle is driving in the autonomous mode, and adjusting (changing) the operation amount of the driver to prevent the collision with the surrounding vehicle.

The memory 10 may include at least one storage medium of a memory in a flash memory type, a hard disk type, a micro type, the type of a card (e.g., a Security Digital (SD) card or an eXtreme digital card), a Random Access Memory (RAM), a Static RAM (SRAM), a Read Only Memory (ROM), a Programmable ROM (PROM), an Electrically Erasable and Programmable ROM (EEPROM), a magnetic RAM (MRAM), a magnetic disk-type memory, or an optical disk-type memory.

The internetworking device 20 is a module to provide an interface for communication with the sensor 200, the navigation system 300, the autonomous driving system 400, the braking system 500, the driving system 600, and the steering system 700 to collect various pieces of information.

The input device 30 may receive the operation amount of a driver, when the driver is involved in the behavior of the autonomous vehicle in the autonomous driving mode (for example, when the driver operates a brake pedal, an accelerator pedal, or a steering wheel).

The input device 30 may receive an operation amount (accelerating amount) of the accelerator pedal from an Accel-pedal Position Sensor (APS), and may receive an operation amount (braking amount) of the brake pedal from a brake-pedal position sensor (BPS). In addition, an operation amount (steering amount) of the steering wheel may be input from the steering angle sensor.

In addition, the input device 30 may receive the operation amount of the accelerator pedal, the operation amount of the brake pedal, and the operation amount of the steering wheel through a vehicle network. In this case, the vehicle network may include Controller Area Network (CAN), Controller Area Network with Flexible Data-rate (CAN FD), Local Interconnect Network (LIN), FlexRay, Media Oriented Systems Transport (MOST), or Ethernet.

The controller 40 may perform the overall control such that the components normally perform the respective functions. In addition, the controller 40 may be implemented in the form of hardware or software, and may be implemented in the form of the combination of the hardware and the software. Preferably, the controller 40 may be implemented with a micro-processor, but the present disclosure is not limited thereto.

Especially, the controller 40 may perform various control operations in the process of predicting the collision with a surrounding vehicle, which is caused by an operation amount (e.g., a braking amount, an accelerating amount, or a steering amount) of a driver, when the driver is involved in driving while the autonomous vehicle is driving in the autonomous mode, and adjusting (changing) the operation amount of the driver to prevent the collision with the surrounding vehicle.

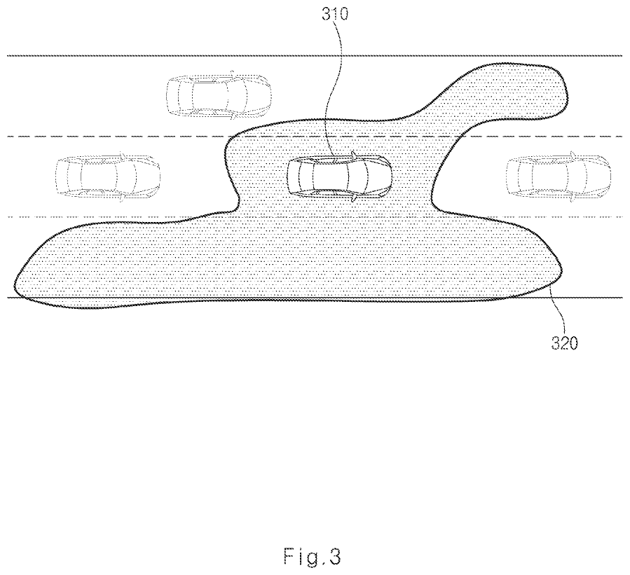

When an autonomous vehicle 310 is positioned in a safety zone 320 by adjusting the operation amount of the driver (see, e.g., FIG. 3), the controller 40 may transfer a control right over the autonomous vehicle 310 to the driver.

The controller 40 may transfer the control right over the autonomous vehicle 310 to the driver when the total time for which the operation amount of the driver is adjusted exceeds a reference time (for example, 30 minutes).

The controller 40 may transfer the control right over the autonomous vehicle 310 to the driver when the number of times that the operation amount of the driver is adjusted exceeds a reference count (for example, three counts).

FIG. 2B is a block diagram illustrating a detailed configuration of a behavior controlling apparatus of an autonomous vehicle, according to an embodiment of the present disclosure.

As illustrated in FIG. 2B, according to an embodiment of the present disclosure, the controller 40 provided in the behavior controlling apparatus 100 of the autonomous vehicle may include a safety zone setting device 41, a moving path predicting device 42, a deviation determining device 43, and a steering amount adjusting device 44.

The safety zone setting device 41 may set the safety zone 320, in which the collision with the surrounding vehicle will not occur, based on driving information (a position, a speed, or a driving direction) of a surrounding vehicle, which is acquired through the sensor 200, information (a current position, a destination, road information, or path information) acquired through the navigation system 300, and driving information (a speed, a steering amount, a braking amount, or an accelerating amount) of the autonomous vehicle 310, which is acquired through the vehicle network.

The moving path predicting device 42 may predict the driving path of the autonomous vehicle 310, based on the steering amount of the driver.

The deviation determining device 43 may determine whether the autonomous vehicle 310 deviates from the safety zone 320 when following the driving path predicted by the moving path predicting device 42.

The steering amount adjusting device 44 may adjust the steering amount of the driver to prevent the autonomous vehicle 310 from deviating from the safety zone 320, when the autonomous vehicle 310 deviates from the safety zone 320.

Hereinafter, a process that the controller 40 predicts the collision with a surrounding vehicle based on the operation amount of the driver will be described with reference to FIGS. 3 to 6.

FIG. 3 illustrates a safety zone set by a controller provided in a behavior controlling apparatus of an autonomous vehicle, according to an embodiment of the present disclosure.

As illustrated in FIG. 3, the controller 40 provided in the behavior controlling apparatus 100 of the autonomous vehicle may set the safety zone 320, in which the collision with the surrounding vehicle does not occur, based on driving information (a position, a speed, or a driving direction) of a surrounding vehicle, which is acquired through the sensor 200, information (a current position, a destination, road information, or path information) acquired through the navigation system 300, and driving information (a speed, a steering amount, a braking amount, or an accelerating amount) of the autonomous vehicle 310, which is acquired through the vehicle network. The technology of setting the safety zone 320 is well-known, so the details thereof will be omitted.

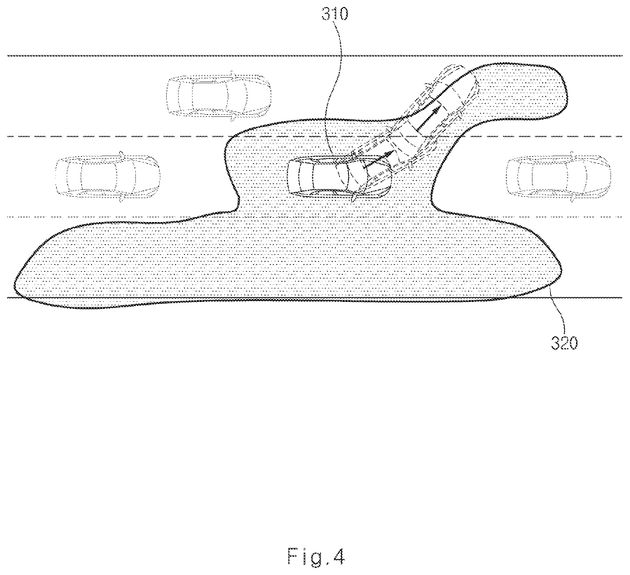

FIG. 4 is a view illustrating a process that the controller provided in the behavior controlling apparatus of the autonomous vehicle adjusts the steering amount of the driver, according to an embodiment of the present disclosure.

As illustrated in FIG. 4, according to an embodiment of the present disclosure, the controller 40 provided in the behavior controlling apparatus 100 of the autonomous vehicle may predict the collision with the surrounding vehicle, when the behavior of the autonomous vehicle 310 is controlled based on the steering amount of the driver, which is input through the input device 30. In this case, the steering amount is a concept of including a steering angle and a time to maintain the steering angle.

For an example, the controller 40 predicts the driving path of the autonomous vehicle 310 based on the steering amount of the driver, may determine whether the autonomous vehicle 310 deviates from the safety zone 320 when following the predicted driving path, and may adjust the steering amount of the driver to prevent the autonomous vehicle 310 from deviating from the safety zone 320, when the autonomous vehicle 310 deviates from the safety zone 320. In this case, the controller 40 may predict the driving path of the autonomous vehicle 310 while adjusting (decreasing or increasing) the steering amount of the driver, may determine the steering amount of the driver, which corresponds to the driving path to prevent the autonomous vehicle 310 from deviating from the safety zone 320, and may control the behavior of the autonomous vehicle 310 based on the determined steering amount of the driver.

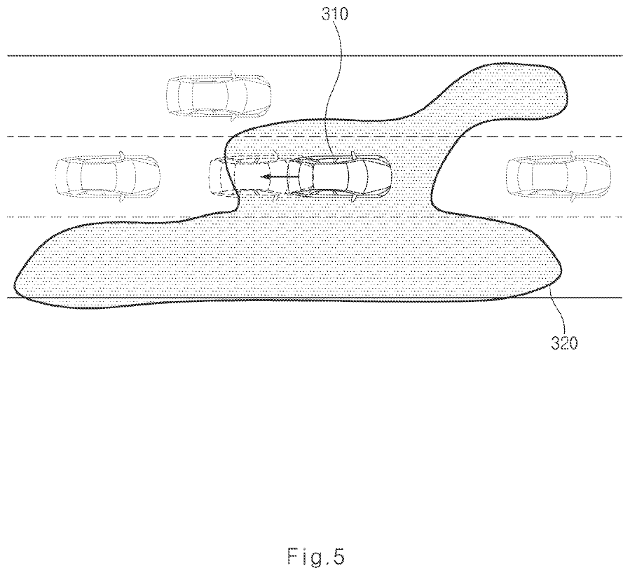

FIG. 5 is a view illustrating a process that a controller provided in a behavior controlling apparatus of an autonomous vehicle adjusts a braking amount of a driver, according to an embodiment of the present disclosure.

As illustrated in FIG. 5, according to an embodiment of the present disclosure, the controller 40 provided in the behavior controlling apparatus 100 of the autonomous vehicle may predict the collision with the surrounding vehicle, when controlling the behavior of the autonomous vehicle 310, based on the braking amount of the driver, which is input through the input device 30. In this case, the braking amount is a concept of including braking force and a time to maintain the braking force.

For an example, the controller 40 predicts the position of the autonomous vehicle 310 based on the braking amount of the driver, may determine whether the predicted position of the autonomous vehicle 310 is out of the safety zone 320, and may adjust the braking amount of the driver to prevent the position of the autonomous vehicle 310 from being out of the safety zone 320, when the position of the autonomous vehicle 310 is out of the safety zone 320.

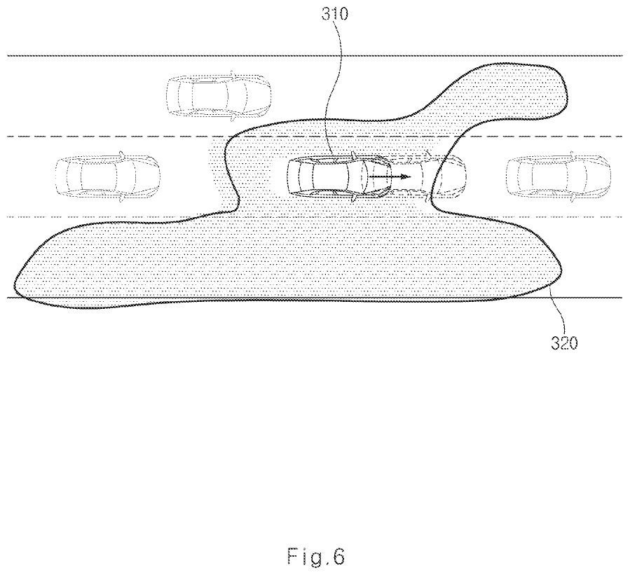

FIG. 6 is a view illustrating a process that a controller provided in a behavior controlling apparatus of an autonomous vehicle adjusts an accelerating amount of a driver, according to an embodiment of the present disclosure.

As illustrated in FIG. 6, according to an embodiment of the present disclosure, the controller 40 provided in the behavior controlling apparatus 100 of the autonomous vehicle may predict the collision with the surrounding vehicle, when controlling the behavior of the autonomous vehicle 310, based on the accelerating amount of the driver, which is input through the input device 30. In this case, the accelerating amount is a concept of including an acceleration and a time to maintain the acceleration.

For an example, the controller 40 may predict the position of the autonomous vehicle 310 based on the accelerating amount of the driver, may determine whether the predicted position of the autonomous vehicle 310 is out of the safety zone 320, and may adjust the accelerating amount of the driver to prevent the position of the autonomous vehicle 310 from being out of the safety zone 320, when the position of the autonomous vehicle 310 is out of the safety zone 320.

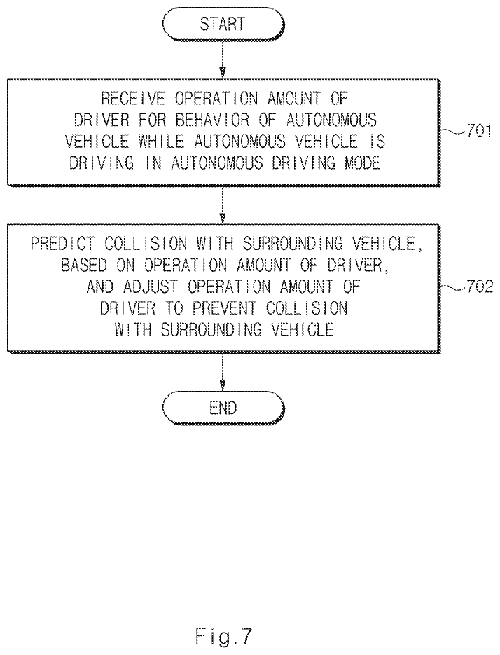

FIG. 7 is a flowchart illustrating a method for controlling a behavior of an autonomous vehicle, according to an embodiment of the present disclosure.

First, the input device 30 receives an operation amount of a driver for the behavior of the autonomous vehicle while the autonomous vehicle is driving in an autonomous driving mode (701).

Thereafter, the controller 40 predicts the collision with a surrounding vehicle, based on the operation amount of the driver, and adjusts the operation amount of the driver to prevent the collision with the surrounding vehicle (702).

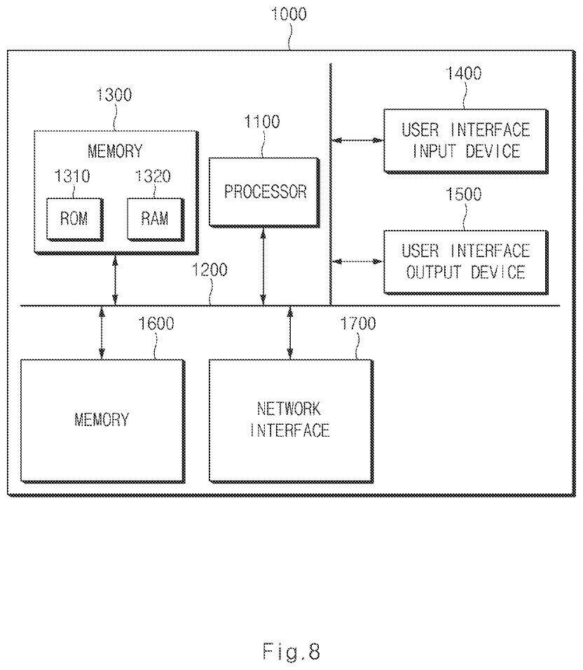

FIG. 8 is a block diagram illustrating a computing system to execute the method for controlling the behavior of the autonomous vehicle, according to an embodiment of the present disclosure.

Referring to FIG. 8, according to an embodiment of the present disclosure, the method for controlling the behavior of the autonomous vehicle may be implemented through the computing system. A computing system 1000 may include at least one processor 1100, a memory 1300, a user interface input device 1400, a user interface output device 1500, a memory (i.e., storage) 1600, and a network interface 1700, which are connected with each other via a system bus 1200.

The processor 1100 may be a central processing unit (CPU) or a semiconductor device for processing instructions stored in the memory 1300 and/or the memory 1600. Each of the memory 1300 and the memory 1600 may include various types of volatile or non-volatile storage media. For example, the memory 1300 may include a read only ROM 1310 and a RAM 1320.

Thus, the operations of the methods or algorithms described in connection with the embodiments disclosed in the present disclosure may be directly implemented with a hardware module, a software module, or the combinations thereof, executed by the processor 1100. The software module may reside on a storage medium (i.e., the memory 1300 and/or the memory 1600), such as a RAM memory, a flash memory, a ROM, memory an erasable and programmable ROM (EPROM), an electrically EPROM (EEPROM), a register, a hard disc, a solid state drive (SSD), a removable disc, or a compact disc-ROM (CD-ROM). The exemplary storage medium may be coupled to the processor 1100. The processor 1100 may read out information from the storage medium and may write information in the storage medium. Alternatively, the storage medium may be integrated with the processor 1100. The processor and storage medium may reside in an application specific integrated circuit (ASIC). The ASIC may reside in a user terminal. Alternatively, the processor and storage medium may reside as separate components of the user terminal.

As described above, according to an embodiment of the present disclosure, in the apparatus for controlling the behavior of the autonomous vehicle and the method for the same, the collision with a surrounding vehicle, which is caused by an operation amount (e.g., a braking amount, an accelerating amount, or a steering amount) of the driver, may be predicted when the driver is involved in driving while the autonomous vehicle is driving in the autonomous mode, and the operation amount of the driver may be adjusted (changed) to prevent the collision with the surrounding vehicle, thereby preventing a traffic accident from being caused as the driver is involved in the driving.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, embodiments of the present disclosure are not intended to limit the technical spirit of the present disclosure, but are provided only for the illustrative purpose. The scope of protection of the present disclosure should be construed by the attached claims, and all equivalents thereof should be construed as being included within the scope of the present disclosure.

What is claimed is:

1. An apparatus configured to control a behavior of an autonomous vehicle, the apparatus comprising:
an input device configured to receive an operation amount of a driver for the behavior of the autonomous vehicle; and
a controller configured to, while the autonomous vehicle is driving in an autonomous vehicle mode, receive the operation amount of the driver through the input device, predict a collision with a surrounding vehicle based on the operation amount of the driver, and adjust the operation amount of the driver to prevent the collision with the surrounding vehicle.

2. The apparatus of claim 1, wherein the controller is configured to set a safety zone based on the autonomous vehicle, which is driving, to prevent the collision with the surrounding vehicle.

3. The apparatus of claim 2, wherein the input device is configured to receive a steering amount of the driver from a steering angle sensor.

4. The apparatus of claim 3, wherein the controller is configured to:
predict a driving path of the autonomous vehicle based on the steering amount of the driver;
determine whether the autonomous vehicle deviates from the safety zone on the predicted driving path; and
adjust the steering amount of the driver to prevent the autonomous vehicle from deviating from the safety zone.

5. The apparatus of claim 2, wherein the input device is configured to receive a braking amount of the driver from a brake pedal position sensor.

6. The apparatus of claim 5, wherein the controller is configured to:
predict a position of the autonomous vehicle based on the braking amount of the driver;
determine whether the predicted position of the autonomous vehicle is out of the safety zone; and
adjust the braking amount of the driver to prevent the position of the autonomous vehicle from being out of the safety zone.

7. The apparatus of claim 2, wherein the input device is configured to receive an accelerating amount of the driver from an accelerator pedal sensor.

8. The apparatus of claim 7, wherein the controller is configured to:
predict a position of the autonomous vehicle based on the accelerating amount of the driver;
determine whether the predicted position of the autonomous vehicle is out of the safety zone; and
adjust the accelerating amount of the driver to prevent the position of the autonomous vehicle from being out of the safety zone.

9. The apparatus of claim 2, wherein the controller is configured to transfer a control right over the autonomous vehicle to the driver when the autonomous vehicle is positioned in the safety zone by adjusting the operation amount of the driver.

10. The apparatus of claim 2, wherein the controller is configured to transfer a control right over the autonomous vehicle to the driver when a total time for which the operation amount of the driver is adjusted exceeds a reference time.

11. A method for controlling a behavior of an autonomous vehicle, the method comprising:
receiving an operation amount of a driver for the behavior of the autonomous vehicle while the autonomous vehicle is driving in an autonomous driving mode;
predicting a collision with a surrounding vehicle based on the operation amount of the driver; and
adjusting the operation amount of the driver to prevent the collision with the surrounding vehicle.

12. The method of claim 11, wherein adjusting the operation amount of the driver comprises setting a safety zone based on the autonomous vehicle which is driving to prevent the collision with the surrounding vehicle.

13. The method of claim 12, wherein receiving the operation amount of the driver comprises receiving a steering amount of the driver from a steering angle sensor.

14. The method of claim 13, wherein adjusting the operation amount of the driver comprises:
predicting a driving path of the autonomous vehicle based on the steering amount of the driver;
determining whether the autonomous vehicle deviates from the safety zone on the predicted driving path; and
adjusting the steering amount of the driver to prevent the autonomous vehicle from deviating from the safety zone.

15. The method of claim 12, wherein receiving the operation amount of the driver comprises receiving a braking amount of the driver from a brake pedal position sensor.

16. The method of claim 15, wherein adjusting the operation amount of the driver comprises:
predicting a position of the autonomous vehicle based on the braking amount of the driver;
determining whether the predicted position of the autonomous vehicle is out of the safety zone; and
adjusting the braking amount of the driver to prevent the position of the autonomous vehicle from being out of the safety zone.

17. The method of claim 12, wherein receiving the operation amount of the driver comprises receiving an accelerating amount of the driver from an accelerator pedal sensor.

18. The method of claim 17, wherein adjusting the operation amount of the driver comprises:
predicting a position of the autonomous vehicle based on the accelerating amount of the driver;
determining whether the predicted position of the autonomous vehicle is out of the safety zone; and
adjusting the accelerating amount of the driver to prevent the position of the autonomous vehicle from being out of the safety zone.

19. The method of claim 12, further comprising transferring a control right over the autonomous vehicle to the driver based on the autonomous vehicle being positioned in the safety zone by adjusting the operation amount of the driver.

20. The method of claim 12, further comprising transferring a control right over the autonomous vehicle to the driver based on a total time for which the operation amount of the driver is adjusted exceeding a reference time.
